(19) United States
(12) Patent Application Publication
(10) Pub. No.: US 2020/0180583 A1
(43) Pub. Date: Jun. 11, 2020

(54) Method And Apparatus For Monitoring Replacement Of An Air Dryer Cartridge

(71) Applicant: Bendix Commercial Vehicle Systems LLC, Elyria, OH (US)

(72) Inventors: Timothy Carritte, Avon Lake, OH (US); Aaron S. Wilfing, Vermillion, OH (US); Frank Uhelsky, Medina, OH (US)

(21) Appl. No.: 16/214,259

(22) Filed: Dec. 10, 2018

(51) Int. Cl. B60T 17/00; B60T 17/22

(52) U.S. Cl. CPC B60T 17/004; B60T 17/221

(57) ABSTRACT

An air dryer assembly that monitors the replacement of an air dryer cartridge comprises a first air dryer cartridge, an air dryer base for receiving the first air dryer cartridge and a state change device positioned between the air dryer cartridge and air dryer base. The state change device changes from a first state to a second state in response to the first air dryer cartridge being removed from the air dryer base. The state change device changes to a third state when a second air dryer cartridge is removably attached to the air dryer base.

### BACKGROUND

The present invention relates to embodiments of an apparatus and method to determine the replacement of an air dryer cartridge. Vehicles equipped with air brake systems normally have air dryers to provide clean, dry air to downstream components of the air brake system. An air dryer cartridge having desiccant material requires replacement periodically as the desiccant material becomes saturated or fouled. Today, manual systems exist that monitor the time between cartridge changes based on the time between a first manual reset and a second manual reset. These systems rely on the vehicle operator or mechanic to remember to hit the reset switch each time the cartridge is exchanged. The reset switch may be remote from the air dryer cartridge. There is a need for an improved method of determining an air dryer cartridge replacement has occurred.

### SUMMARY

Various embodiments of an apparatus for determining an air dryer cartridge has been replaced are presented. In one example, an air dryer assembly comprises a first air dryer cartridge; an air dryer base for receiving the first air dryer cartridge; and a state change device positioned between the air dryer cartridge and air dryer base. The state change device changes from a first state to a second state in response to the first air dryer cartridge being removably attached to the air dryer base, changes from the second state to a third state in response to the first air dryer cartridge being removed from the air dryer base and changes from the third state to the first state in response to a second air dryer cartridge being removably attached to the air dryer base.

In accordance with another aspect, various methods of determining a cartridge change on an air dryer are presented. In one example, a method for determining an air dryer cartridge replacement comprises receiving a signal from a state change device indicating a first air dryer cartridge is installed on an air dryer base and removing the first air dryer cartridge from the air dryer base. The method continues with receiving a second signal from the state change device; attaching a second air dryer cartridge to the air dryer base and receiving a third signal from the state change device indicating the second air dryer cartridge is installed on the air dryer base.

### BRIEF DESCRIPTION OF THE DRAWINGS

In the accompanying drawings which are incorporated in and constitute a part of the specification, embodiments of the invention are illustrated, which, together with a general description of the invention given above, and the detailed description given below, serve to exemplify the embodiments of this invention.

FIG. 1 illustrates an air dryer assembly according to one example of this invention.

FIG. 2 illustrates a cross section of the air dryer assembly of FIG. 1.

FIGS. 3A-3D illustrate symbolic representations of state change devices and circuits for use in the air dryer assembly of FIG. 1.

FIG. 4 illustrates a method of determining a replacement of an air dryer cartridge, according to one example of this invention.

### DETAILED DESCRIPTION

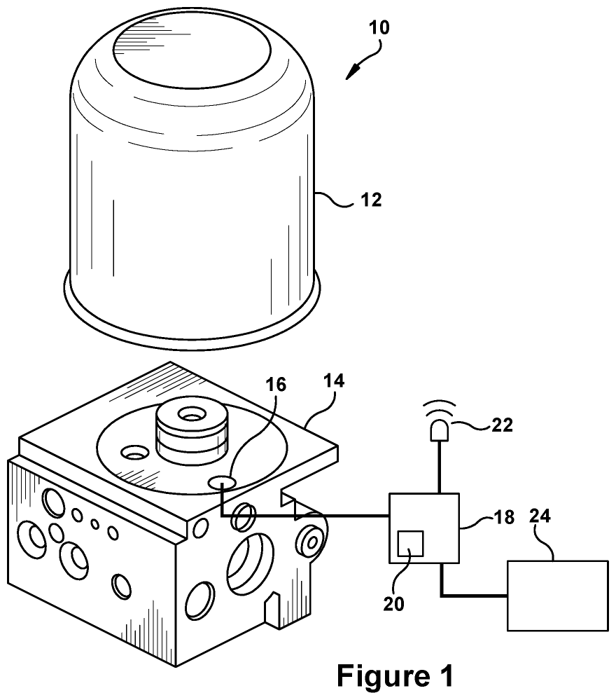

FIG. 1 illustrates an air dryer assembly 10 for use in a vehicle air brake system according to one example of this invention. The air dryer assembly 10 includes an air dryer cartridge 12. The air dryer cartridge 12 may contain desiccant material for removing moisture and filter(s) for removing oil and other contaminants from a compressed air stream.

The air dryer assembly 10 includes an air dryer base 14 for receiving the air dryer cartridge 12. The air dryer cartridge 12 is removably attached to the air dryer base 14 by threads or other means of fastening. An air tight seal will exist between the air dryer cartridge 12 and the air dryer base 14 when the air dryer cartridge 12 is installed on the air dryer base 14. Compressed air enters the air dryer base 14 and passes through the air dryer cartridge 12 to remove moisture and other contaminants. The clean, dry air then exits the air dryer base 14 for use by the air brake system.

The air dryer assembly 10 includes a state change device 16. The state change device 16 is positioned such that it is between the air dryer cartridge 12 and the air dryer base 14 when the air dryer assembly 10 is in use. The state change device 16 may be affixed to the air dryer base 14 or may be a separable device. The state change device 16 transmits state changes in response to the air dryer cartridge 12 engaging the state change device 16.

The air dryer assembly 10 includes a controller 18. The controller 18 may be mounted on the air dryer base 14 or may be remote from the air dryer base 14. The controller 18 may provide power for the state change device 16. The controller 18 includes a processor with control logic 20 for receiving and transmitting signals. The control logic 20 may include volatile, non-volatile memory, solid state memory, flash memory, random-access memory (RAM), read-only memory (ROM), electronic erasable programmable read-only memory (EEPROM), variants of the foregoing memory types, combinations thereof, and/or any other type(s) of memory suitable for providing the described functionality and/or storing computer-executable instructions for execution by the control logic 20.

The control logic 20 receives information regarding each state change of the state change device 16. The state change device 16 may transmit state changes via a direct connection to the controller 18 or wirelessly. The control logic 20 determines whether an air dryer cartridge 12 is installed on the air dryer base 14 based on the state of the state change device 16. The control logic 20 also determines whether another air dryer cartridge has been installed on the air dryer base 14 by monitoring the change of state of the state change device 16 as will be described.

The control logic 20 may also include a cartridge change counter. The cartridge change counter is incremented each time the state change device 16 changes from a first state to a second state. The control logic 20 may also include a timer for measuring elapsed time between each change of state of the state change device 16.

The control logic 20 may also transmit signals to other devices to indicate the status of the air dryer assembly 10. Other devices on the vehicle may include an indicator lamp 22 or a driver information system 24. The control logic 20 transmits a signal to illuminate the indicator lamp 22 in response to the timer being greater than a predetermined time, for example. When the indicator lamp 22 is on, the driver or mechanic is reminded to change the air dryer cartridge 12.

In one example, the state change device 16 may have multiple states. The state change device 16 will cycle through each of the states each time the air dryer cartridge 12 is removed and replaced with a second air dryer cartridge. The state change device 16 may be a variable resistive device. In a first state, when the air dryer cartridge 12 is attached to the air dryer base 14, the state change device 16 transmits a signal equivalent to the power supplied to the state change device 16. In a second state, when the air dryer cartridge 12 has been removed from the air dryer base 14, the state change device 16 transmits a signal that is a percentage of the power signal.

The state change device 16 may remained powered via the controller 18, even when a vehicle ignition is turned off. However, the state change device 16 does not need constant power in order to indicate a change of state, as will be explained.

Therefore, an apparatus for determining when an air dryer cartridge has been replaced comprises a first air dryer cartridge; an air dryer base for receiving the first air dryer cartridge; and a state change device positioned between the air dryer cartridge and air dryer base. The state change device changes from a first state to a second state in response to the first air dryer cartridge being removably attached to the air dryer base, changes from the second state to a third state in response to the first air dryer cartridge being removed from the air dryer base and changes from the third state to the first state in response to a second air dryer cartridge being removably attached to the air dryer base.

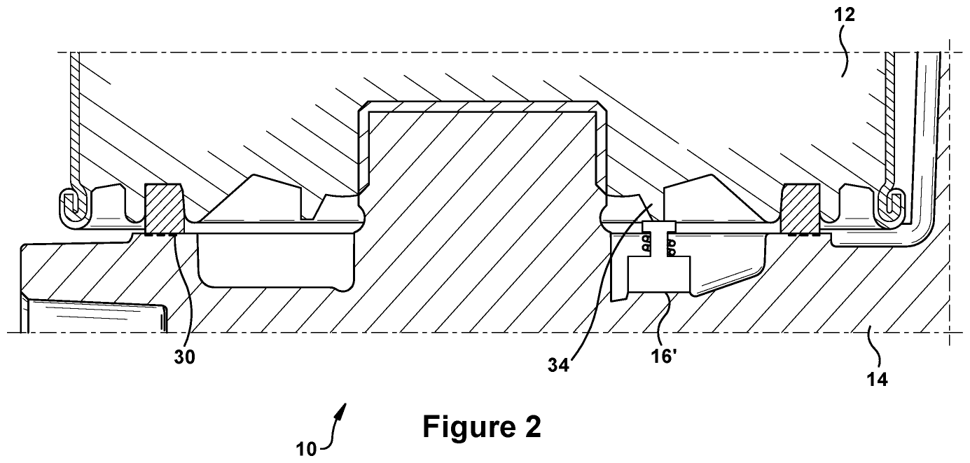

FIG. 2 illustrates a cross-section of the air dryer assembly 10 having a state change device 16′ as a multi-position pushbutton switch. In this example, the air dryer cartridge 12 is fully seated on the air dryer base 14. A sealing ring 30 may be placed between the air dryer cartridge 12 and the air dryer base 14. The state change device 16′ is located radially inward of the sealing ring 30. However, the state change device 16′ may be located outward of the sealing ring 30 as the state change device 16′ is not required to be in a pressurized location.

The state change device 16′ is shown in its depressed, or second state, indicating that the air dryer cartridge 12 is installed on the air dryer base 14. The state change device 16′ will physically change position from a depressed state to an extended state when the air dryer cartridge 12 has been removed from the air dryer base 14. The state change device 16′ will change from the extended state, or first state, to the depressed state, or second state when the air dryer cartridge 12 is installed on the air dryer base 14.

In this example, a circumferential protrusion 34 on the air dryer cartridge 12 is present. The protrusion 34 will maintain the state change device 16′ in the depressed position when the air dryer cartridge 12 is installed on the air dryer base 14. When the air dryer cartridge 12 is removed, the state change device 16′ is biased to the released position. The location of the state change device 16′ on the air dryer base 14 may be such that if the protrusion 34 is not present on the air dryer cartridge 12, then the state change device 16′ may not be depressed even if the air dryer cartridge 12 is installed on the air dryer base 14.

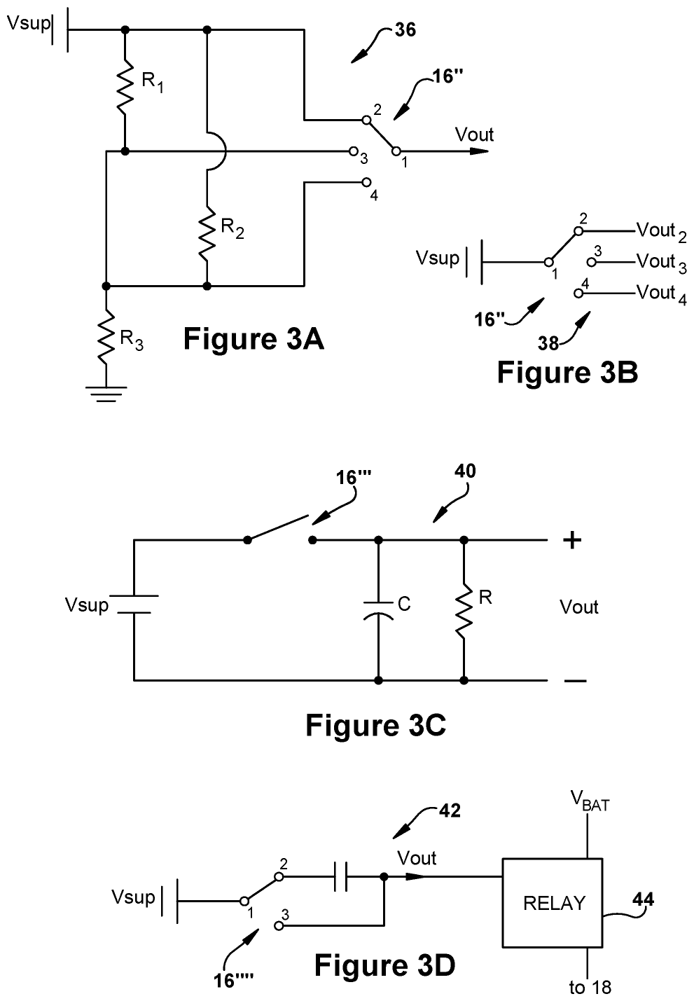

FIG. 3A illustrates schematically a circuit 36 showing a multi-positional switch as the state change device 16″. The circuit 36 may be located in the controller 18. One example of a multi-positional switch is a single pole double throw switch, such as a Series WB environmentally sealed pushbutton switch available from NKK switches of Scottsdale Ariz.

The state change device 16″ is in position 1-2, or its second state, when the air dryer cartridge 12 is installed on the air dryer base. In position 1-2, the switching device 16 receives power from Vsup such that Vout is approximately equal to Vsup. In this configuration, the state change device 16″ cycles through three states.

The state change device 16″ moves to position 1-3 when the air dryer cartridge 12 is removed from the air dryer base 14, or its first state. In position 1-3, Vout is less than Vsup due to the resistor divider circuit formed by R1 and R3. When a new air dryer cartridge is installed on the air dryer base 14, the state change device 16″ cycles to position 1-4. Vout is less than Vsup due to the resistor divider circuit formed by R2 and R3. The state change device 16″ will then continue to cycle through these positions as air dryer cartridges are removed and replaced on the air dryer base 14.

Vout is read by the controller 18 and is indicative of the state of the state change device 16″. The control logic 20 can then determine from the differences Vout that the position of the state change device 16″ has changed. When the state change device 16″ changes from position 1-2 to position 1-3 then position 1-4, the control logic 20 determines that the air dryer cartridge 12 has been replaced with a new air dryer cartridge.

The control logic 20 may then send a signal to turn off the indicator lamp 22, which may have been turned on due to the length of time since the last air dryer cartridge replacement. The control logic 20 may also send a signal to the driver indicator unit 24 to indicate the date and time when the air dryer cartridge was replaced.

FIG. 3B illustrates an example of another circuit 38 using multi-positional state change device 16″. In this example, Vout2 reads as Vsup when state change device 16″ is in position 1-2, Vout3 reads as Vsup when state change device 16″ is in position 1-3 and Vout4 reads as Vsup when state change device 16″ is in position 1-4. When the state change device 16″ changes from position 1-2 to position 1-3 then position 1-4, the control logic 20 determines that the air dryer cartridge 12 has been replaced with a new air dryer cartridge.

FIG. 3C illustrates an example capacitive discharge circuit 40 to be used with an single pole, single throw type switch as the state change device 16′″. The circuit 40 may be located in the controller 18. When the state change device 16′″ is closed, as when the air dryer cartridge 12 is installed, the state change device 16′″ is in the second state. The capacitor is then charged and the voltage Vout can be read by the control logic 20. Vout will be approximately the same as Vsup. When the state change device 16′″ is open, as when the air dryer cartridge 12 is removed, the state change device 16′″ is in the first state. The capacitor starts to discharge and the voltage Vout will decrease. The control logic 20 looks for the change in Vout to indicate removal of the air dryer cartridge 12. The voltage at Vout will decrease the longer the state change device 16′″ remains open. The capacitor will begin to charge as soon as the state change device 16′″ returns to the second state. The state change device 16′″ may be a normally open switch connected to a capacitive discharge circuit.

FIG. 3D illustrates another circuit 42 to be used with a remote relay device 44. In this example, the state change device 16″″ is a single pole double throw style switch. When the air dryer cartridge 12 in installed, the state change device 16″″ is in position 1-3 such that Vsup is supplied to Vout and subsequently the relay device 44. In this example, the relay device 44 will provide Vbat to the controller 18 only when the air dryer cartridge 12 is installed in order to save power.

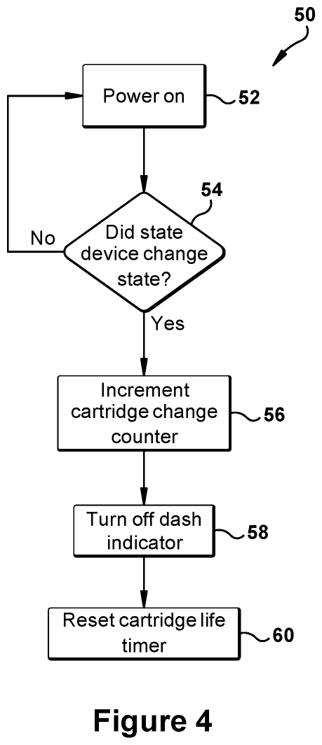

FIG. 4 illustrates a method 50 of determining whether the air dryer cartridge 12 has been replaced. In step 52, the vehicle ignition power is turned on. Power (Vsup) may have remained to the state change device 16 via the controller 18. The controller 18 receives the state of the state change device 16 and determines if the state change device 16 changed state since the last ignition power cycle, as in step 54. The state of the state change device 16 can be determined by reading Vout. If the state change device 16 is in the same state as it was from the last power on, such that Vout remained the same value, the method 50 returns to step 52.

If the state change device 16 did change state, the cartridge change counter in the control logic 20 is incremented in step 56. The indicator lamp 22 may be turned off in step 58 to indicate that a new cartridge has been installed on the air dryer base. In step 52, the cartridge life timer is reset to begin counting the life of the replacement air dryer cartridge. The cartridge change counter in the control logic 20 is incremented when the replacement air dryer cartridge is installed.

Therefore, a method for determining an air dryer cartridge replacement comprises receiving a first signal from a state change device indicating a first air dryer cartridge is installed on an air dryer base and removing the first air dryer cartridge from the air dryer base. The method continues with receiving a second signal from the state change device; attaching a second air dryer cartridge to the air dryer base and receiving a third signal from the state change device indicating the second air dryer cartridge is installed on the air dryer base.

While the present invention has been illustrated by the description of embodiments thereof, and while the embodiments have been described in considerable detail, it is not the intention of the applicants to restrict or in any way limit the scope of the appended claims to such detail. Additional advantages and modifications will readily appear to those skilled in the art. Therefore, the invention, in its broader aspects, is not limited to the specific details, the representative apparatus, and illustrative examples shown and described. Accordingly, departures may be made from such details without departing from the spirit or scope of the applicant's general inventive concept.

We claim:

1. An air dryer assembly comprising:
a first air dryer cartridge;
an air dryer base for receiving the first air dryer cartridge; and
a state change device positioned between the first air dryer cartridge and the air dryer base; wherein the state change device changes from a first state to a second state in response to the first air dryer cartridge being removably attached to the air dryer base, changes from the second state to a third state in response to the first air dryer cartridge being removed from the air dryer base and changes from the third state to the first state in response to a second air dryer cartridge being removably attached to the air dryer base.

2. The air dryer assembly as in claim 1, further comprising a controller, wherein the state change device communicates with the controller.

3. The air dryer assembly as in claim 2, the controller further incrementing a cartridge change counter upon receiving a signal indicating the state change device changed from the second state to the third state and a signal indicating the state change device changed from the third state to the first state.

4. The air dryer assembly as in claim 2, the controller further resetting a dash indicator upon receiving a signal indicating the state change device changed from the second state to the third state and a signal indicating the state change device changed from the third state to the first state.

5. The air dryer assembly as in claim 2, wherein state change device further receives power from the controller.

6. The air dryer assembly as in claim 1, wherein the state change device is part of a capacitive discharge circuit.

7. The air dryer assembly as in claim 1, wherein the state change device is a multi-position switch.

8. The air dryer assembly as in claim 1, wherein the state change device is a variable resistive device.

9. The air dryer assembly as in claim 1, wherein the state change device acts upon a switching device remote from the air dryer assembly to indicate a state change.

10. The air dryer assembly as in claim 1, wherein the third state and the first state are the same state.

11. The air dryer assembly as in claim 1, wherein the first air dryer cartridge and the second air dryer cartridge each include a feature that physically acts upon the state change device when the first air dryer cartridge and second air dryer cartridge are removably attached to the air dryer base.

12. The air dryer assembly as in claim 1, wherein the state change device is affixed to the air dryer base.

13. The air dryer assembly as in claim 12, wherein the state change device is located radially inward from a sealing ring of the air dryer base.

14. A method for determining an air dryer cartridge replacement comprising:
receiving a signal indicating a first air dryer cartridge is installed on an air dryer base;
removing the first air dryer cartridge from the air dryer base;
receiving a second signal, indicating the first air dryer cartridge is removed from the air dryer base;
attaching a second air dryer cartridge to the air dryer base;
receiving a third signal, indicating the second air dryer cartridge is installed on the air dryer base.

15. The method as in claim 14, wherein the third signal is the same as the first signal.

16. The method as in claim 14 further comprising:
resetting a dash indicator in response to receiving the second signal.

17. The method as in claim 14 further comprising;
resetting a cartridge counter in a controller in response to receiving the second signal.

18. A controller for determining an air dryer cartridge replacement comprising:
an input for receiving a signal from a state change device;
an output for transmitting a signal indicative of a replacement of an air dryer cartridge; and
control logic, the control logic determining the replacement of the air dryer cartridge based on the signal from the state change device.
